(19) United States
(12) Patent Application Publication
(10) Pub. No.: US 2012/0170758 A1
(43) Pub. Date: Jul. 5, 2012

(54) MULTI-CHANNEL SOUND PANNER

(75) Inventor: Aaron Eppolito, Santa Cruz, CA (US)

(73) Assignee: APPLE INC., Cupertino, CA (US)

(21) Appl. No.: 13/417,170

(22) Filed: Mar. 9, 2012

Related U.S. Application Data
(62) Division of application No. 11/786,863, filed on Apr. 13, 2007.

(51) Int. Cl. H04R 5/00

(52) U.S. Cl. 381/17

(57) ABSTRACT

A method and apparatus for multi-channel panning is provided. The panner can support an arbitrary number of input channels and changes to configurations to the output sound space. For example, the panner seamlessly handles changes in the number of input channels. Also, the panner supports changes to the number and positions of speakers in the output space. In one embodiment, the panner allows continuous control of attenuation and collapsing. In one embodiment, the panner keeps source channels on the periphery of the sound space when collapsing channels. In one embodiment, the panner allows control over the path by which sources collapse.

### CLAIM OF PRIORITY

The present application is a divisional application of U.S. patent application Ser. No. 11/786,863, entitled “Multi-Channel Sound Panner,” filed on Apr. 13, 2007, which is incorporated by reference herein.

### FIELD OF THE INVENTION

The present invention relates to multi-channel sound panners.

### BACKGROUND

Sound panners are important tools in audio signal processing. Sound panners allow an operator to create an output signal from a source audio signal such that characteristics such as apparent origination and apparent amplitude of the sound are controlled. Some sound panners have a graphical user interface that depicts a sound space having a representation of one or more sound devices, such as audio speakers. As an example, the sound space may have five speakers placed in a configuration to represent a 5.1 surround sound environment. Typically, the sound space for 5.1 surround sound has three speakers to the front of the listener (front left (L) and front right (R), center (C)) and two surround speakers at the rear (surround left (L_{S}) and surround right (R_{S})), and one LFE channel for low frequency effects (LFE). A source signal for 5.1 surround sound has five audio channels and one LFE channel, such that each source channel is mapped to one audio speaker.

When surround sound was initially introduced, dialog was typically mapped to the center speaker, stereo music and sound effects were typically mapped to the left front speaker and the right front speaker, and ambient sounds were mapped to the surround (rear) speakers. Recently, however, all speakers are used to locate certain sounds via panning, which is particularly useful for sound sources such as explosions or moving vehicles. Thus, an audio engineer may wish to alter the mapping of the input channels to sound space speakers, which is where a sound panner is very helpful. Moreover, panning can be used to create the impression that a sound is originating from a position that does not correspond to any physical speaker in the sound space by proportionally distributing sound across two or more physical speakers. Another effect that can be achieved with panning is the apparent width of origination of a sound. For example, a gunshot can be made to sound as if it is originating from a point source, whereas the sound of a supermarket can be made to sound as if it is originating over the entire left side of the sound space.

Conventional sound panners present a graphical user interface to help the operator to both manipulate the source audio signal and to visualize how the manipulated source audio signal will be mapped to the sound space. However, given the number of variables that affect the sound manipulation, and the interplay between the variables, it is difficult to visually convey information to the operator in a way that is most helpful to manipulate the sound to create the desired sound. For example, some of the variables that an operator can control are panning forward, backward, right, and/or left. Further, the source audio data may have many audio channels. Moreover, the number of speakers in the sound space may not match the number of channels of data in the source audio data.

In order to handle this complexity, some sound panners only allow the operator process one channel of source audio at a time. However, processing one channel at a time can be laborious. Furthermore, this technique does not allow audio engineers to effectively coordinate multiple speakers.

Therefore, improved techniques are desired for visually conveying information in a user interface of a sound panner.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating an example user interface (UI) for a sound panner demonstrating a default configuration for visual elements, in accordance with an embodiment of the present invention;

FIG. 2 is a diagram illustrating an example UI for a sound panner demonstrating changes of visual elements from the default configuration of FIG. 1, in accordance with an embodiment of the present invention;

FIG. 3 is a diagram illustrating an example UI for a sound panner demonstrating attenuation, in accordance with an embodiment of the present invention;

FIG. 4 is a diagram illustrating an example UI for a sound panner demonstrating collapsing, in accordance with an embodiment of the present invention;

FIG. 5A, FIG. 5B, and FIG. 5C are diagrams illustrating an example UI for a sound panner demonstrating combinations of collapsing and attenuation, in accordance with embodiments of the present invention;

FIG. 6 is a flowchart illustrating a process of visually presenting how a source audio signal having one or more channels will be heard by a listener in a sound space, in accordance with an embodiment of the present invention.

FIG. 7 is a flowchart illustrating a process of determining visual properties for visual elements in a sound panner UI in accordance with an embodiment of the present invention.

FIG. 8 is a diagram illustrating an example UI for a sound panner demonstrating morphing a visual element, in accordance with embodiments of the present invention;

FIG. 9 is a flowchart illustrating a process of re-balancing source channels based on a combination of attenuation and collapsing, in accordance with an embodiment;

FIG. 10 is a flowchart illustrating a process of panning multiple channels, in accordance with an embodiment;

FIG. 11 depicts a process of collapsing sound along a perimeter of a sound space, in accordance with an embodiment;

FIG. 12 depicts a process of automatically adjusting to the number of source channels, in accordance with an embodiment;

FIG. 13 depicts a process of automatically adjusting to a change in the configuration of the sound space, in accordance with an embodiment;

FIG. 14 is a diagram of an example computer system upon which embodiments of the present invention may be practiced; and.

FIG. 15A, FIG. 15B, and FIG. 15C illustrate three different lines along which a single source channel is collapsed for the same puck movement, in accordance with an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### OVERVIEW

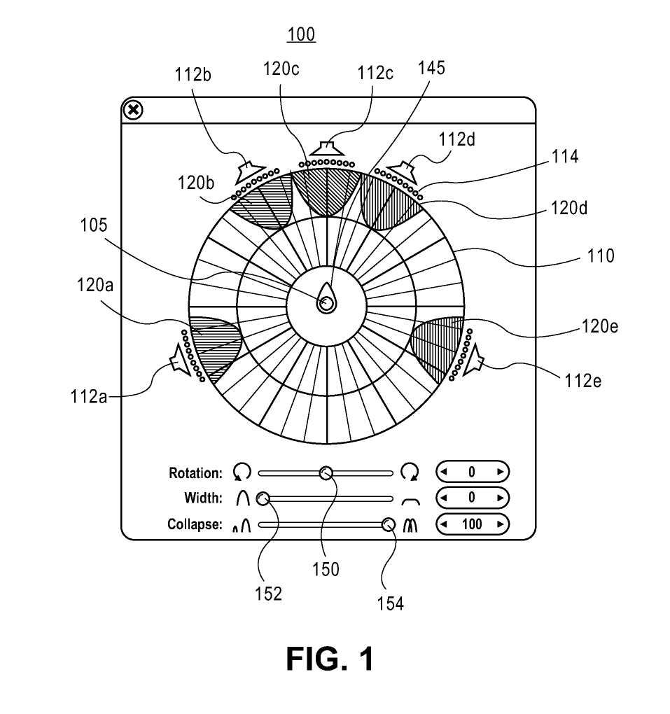

A multi-channel surround panner and multi-channel sound panning are disclosed herein. The multi-channel surround panner, in accordance with an embodiment, allows the operator to manipulate a source audio signal, and view how the manipulated source signal will be heard by a listener at a reference point in a sound space. The panner user interface (UI) displays a separate visual element for each channel of source audio. For example, referring to FIG. 1, the sound space 110 is represented by a circular region with five speakers 112a-112e around the perimeter. The five visual elements 120a-120e, which are arcs in one embodiment, represent five different source audio channels, in this example. In particular, the visual elements 120 represent how each source channel will be heard by a listener at a reference point in the sound space 110. In FIG. 1, the visual elements 120 are in a default position in which each visual element 120 is in front of a speaker 112, which corresponds to each channel being mapped to a corresponding speaker 112.

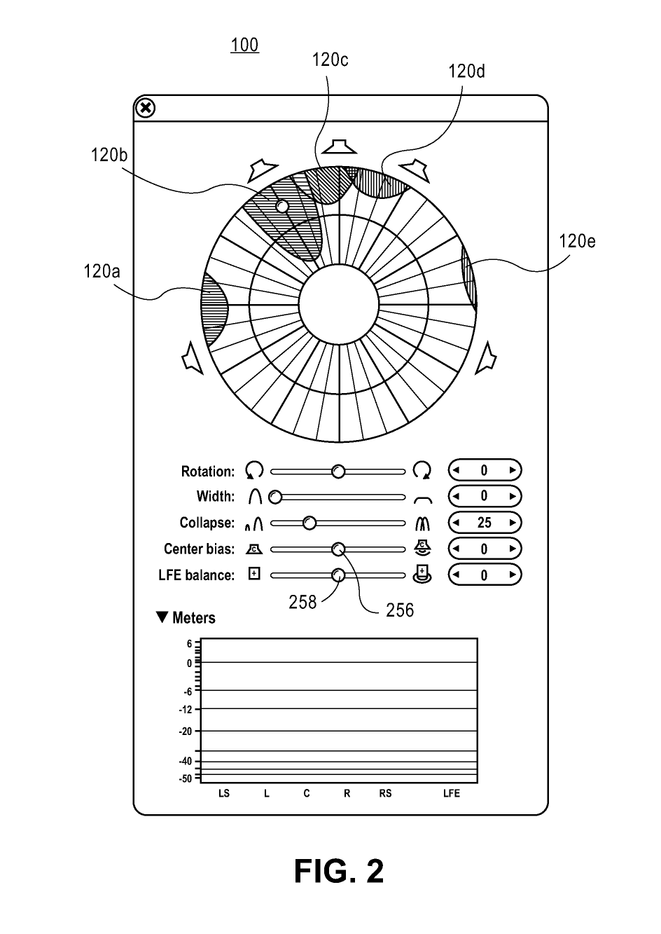

Referring to FIG. 2, as the operator moves a puck 105 within the sound space 110 the sound is moved forward in the sound space 110. This is visually represented by movement of the visual elements 120 that represent source channels. In a typical application, an operator would be in a studio in which there are actual speakers playing to provide the operator with aural feedback. The UI 100 provides the operator with visual feedback to help the operator better understand how the sound is being manipulated. In particular, the UI 100 allows the operator to see how each individual source channel is being manipulated, and how each channel will be heard by a listener at a reference point in the sound space 110.

Not all of the source audio channels are required to be the same audio track. For example, the rear (surround) audio channels could be a track of ambient sounds such as birds singing, whereas the front source audio channels could be a dialog track. Thus, if the rear speakers had birds singing and the front speakers had dialog, as the operator moved the puck 105 forward, the operator would hear the birds' singing move towards the front, and the UI 100 would depict the visual elements 120 for the rear source channels moving towards the front to provide the operator with a visual representation of the sound manipulation of the source channels. Note that the operator can simultaneously pan source audio channels for different audio tracks.

In one embodiment, the puck 105 represents the point at which the collective sound of all of the source channels appears to originate from the perspective of a listener in the middle of the sound space 110. Thus, for example, if the five channels represented a gunshot, then the operator could make the gunshot appear to originate from a particular point by moving the puck 105 to that point.

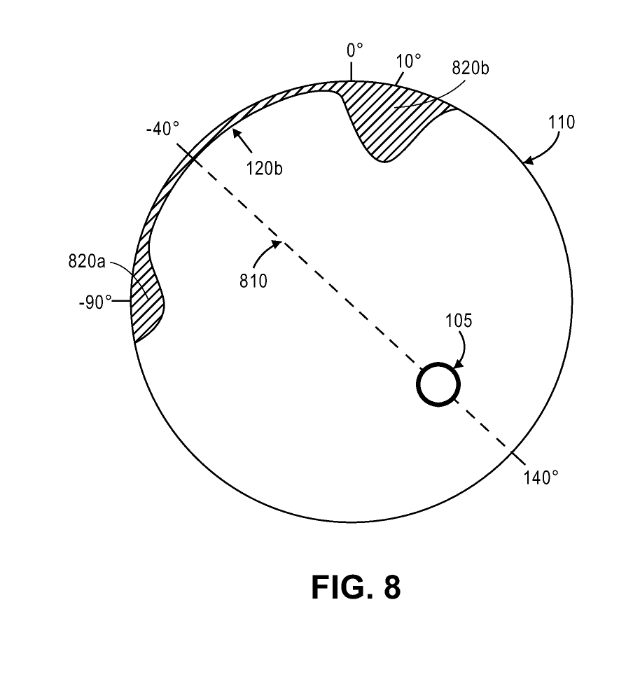

Each visual element 120 depicts the “width” of origination of its corresponding source channel, in one embodiment. The width of the source channel refers to how much of the circumference of the sound space 110 from which the source channel appears to originate, in one embodiment. The apparent width of source channel origination is represented by the width of the visual element 120 at the circumference of the sound space 110, in one embodiment. In one embodiment, the visual element 120 has multiple lobes to represent width. For example, FIG. 8 depicts an embodiment with lobes 820. As a use case, the operator could choose to have a gunshot appear to originate from a point source, while having a marketplace seem to originate from a wide region. Note that the gunshot or marketplace can be a multi-channel sound.

Each visual element depicts the “amplitude gain” of its corresponding source channel, in one embodiment. The amplitude gain of a source channel is based on a relative measure, in one embodiment. The amplitude gain of a source channel is based on absolute amplitude, in one embodiment.

A multi-channel sound panner, in accordance with an embodiment is able to support an arbitrary number of input channels. If the number of input channels changes, the panner automatically adjusts. For example, if an operator is processing a file that starts with a 5.1 surround sound recording and then changes to a stereo recording, the panner automatically adjusts. The operator would initially see the five channels represented in the sound space 110, and then two channels in the sound space 110 at the transition. However, the panner automatically adjusts to apply whatever panner inputs the operator had established in order to achieve a seamless transition.

In one embodiment, the sound space 110 is re-configurable. For example, the number and positions of speakers 112 can be changed. The panner automatically adjusts to the re-configuration. For example, if a speaker 112 is disabled, the panner automatically transfers the sound for that speaker 112 to adjacent speakers 112, in an embodiment.

In one embodiment, the panner supports a continuous control of collapsing and attenuating behavior. Attenuation refers to increasing the strength of one or more channels and decreasing the strength of one or more other channels in order to change the balance of the channels. For example, sound is moved forward by increasing the signal strength of the front channels and decreasing the signal strength of the rear channels. However, the channels themselves are not re-positioned. Collapsing refers to relocating a sound to change the balance. For example, a channel being played only in a rear speaker 112 is re-positioned such that the channel is played in both the rear speaker 112 and a front speaker 112.

In one embodiment, the visual elements 120 are kept at the outer perimeter of the sound space 110 when performing collapsing behavior. For example, referring to FIG. 2, when the puck 105 is moved forward and to the left, each of the visual elements 120 is represented as moving along the perimeter of the sound space 110.

In one embodiment, the path along which collapsed source channels take is variable between one that is on the perimeter of the sound space 110 and one that is not. This continuously variable path, for example, may be directly towards the direction of the puck 105, thus traversing the sound space 100. As an example, the path along which collapsed source channels take could be could be continuously variable between a purely circular path at one extreme, a linear path at the other extreme, and some shape of arc in between.

In one embodiment, the UI has a dominant puck and a subordinate puck per source channel. The location in the sound space 110 for each source channel can be directly manipulated with the subordinate puck for that source. The subordinate pucks move in response to movement of the dominant puck, according to the currently selected path, in an embodiment.

### Example Sound Panner Interface Sound Space

Referring again to FIG. 1, the sound space 110 represents the physical listening environment. In this example UI 100, the reference listening point is at the center of the sound space 110, surrounded by one or more speakers 112. The sound space 110 can support any audio format. That is, there can be any number of speakers 112 in any configuration. In one embodiment, the sound space 110 is circular, which is a convenient representation. However, the sound space 110 is not limited to a circular shape. For example, the sound space 110 could be square, rectangular, a different polygon, or some other shape.

### Speakers

The speakers 112 represent the physical speakers in their relative positions in or around the sound space 110. In this example, the speaker locations are typical locations for a sound space 110 that is compliant with a 5.1 surround sound (LFE speaker not depicted in FIG. 1). Surround Sound standards dictate specific polar locations relative to the listener, and these positions are accurately reflected in the sound space 110, in an embodiment. For example, in accordance with a 5.1 surround sound, the speakers are at 0°, 30°, 110°, −110°, and −30°, with the center speaker at 0°, in this example. The speakers 112 can range in number from 1-n. Further, while the speakers 112 are depicted as being around the outside of the sound space 110, one or more speakers 110 can reside within the boundaries of the sound space 110.

Each speaker 112 can be individually “turned off”, in one embodiment. For example, clicking a speaker 112 toggles that speaker 112 on/off. Speakers 112 that are “off” are not considered in any calculations of where to map the sound of each channel. Therefore, sound that would otherwise be directed to the off speaker 112 is redirected to one or more other speakers 112 to compensate. However, turning a speaker 112 off does not change the characteristics of the visual elements 120, in one embodiment. This is because the visual elements 120 are used to represent how the sound should sound to a listener, in an embodiment.

In one embodiment, a speaker 112 can have its volume individually adjusted. For example, rather than completely turning a speaker 112 off, it could be turned down. In this case, a portion of the sound of the speaker 112 can be re-directed to adjacent speakers 112.

The dotted meters 114 adjacent to each speaker 112 depict the relative amplitude of the output signal directed to that speaker 112. The amplitude is based on the relative amplitude of all of the source channels whose sound is being played on that particular speaker 112.

### Visual Elements that Represent Source Channels

The interface 100 has visual elements 120 to represent source channels. Each visual element 120 corresponds to one source channel, in an embodiment. In particular, the visual elements 120 visually represent how each source channel would be heard by a listener at a reference point in the sound space 110. The visual elements 120 are arcs in this embodiment. However, another shape could be used.

In the example of FIG. 1, the source audio is a 5.1 surround sound. The polar location of each visual element 120 indicates the region of the sound space 110 from which the sound associated with an input channel appears to emanate to a listener positioned in the center of the sound space 110. In FIG. 1, the polar coordinate of each visual element 120 depicts a default position that corresponds to each channel's location in accordance with a standard for the audio source. For example, the default position for the visual element 120c for the center source channel is located at the polar coordinate of the center speaker 112c.

The number of speakers 112 in the sound space 110 may be the same as the number of audio source channels (e.g. 5.1 surround to 5.1 surround) or there may be a mismatch (e.g. Monaural to 5.1 surround). By abstracting the input audio source from the sound space 110 and visually displaying both in terms of a common denominator (the viewer's physical, spatial experience of the sound), the UI 100 allows operators a technique of accomplishing what was traditionally a daunting, unintuitive task.

The color of the visual elements 120 is used to identify source channels, in an embodiment. For example, the left side visual elements 120a, 120b are blue, the center visual element 120c is green, and the right side visual elements 120d, 120e are red, in an embodiment. A different color could be used to represent each source channel, if desired.

The different source audio channels may be stored in data files. Thus, in one embodiment, a data file may correspond to the right front channel of a 5.1 Surround Sound format, for example. However, the data files do not correspond to channels of a particular data format, in one embodiment. For example, a given source audio file is not required to be a right front channel in a 5.1 Surround Sound format, or a left channel of a stereo format, in one embodiment. In this embodiment, a source audio file would not necessarily have a default position in the sound space 110. Therefore, initial sound space 110 positions for each source audio file can be specified by the operator, or possibly encoded in the source audio file.

### Overlapping Visual Elements

Referring to FIG. 2, several of the visual elements 120 overlap each other. Furthermore, when two or more visual elements 120 overlap, the color of the intersecting region is a combination of the colors of the individual visual elements 120. For example, when the front left 120b, center 120c, and front right 120d visual elements overlap, the intersecting region is white, in an embodiment. When the right front visual element 120b and center visual element 120c overlap, the region of intersection is yellow, in an embodiment.

Overlapping visual elements 120 may indicate an extent to which source channels “blend” into each other. For example, in the default position the visual elements 120 are typically separate from each other, which represents that the user would hear the audio of each source channel originating from a separate location. However, if two or more visual elements 120 overlap, this represents that the user would hear a combination of the source channels associated with the visual elements 120 from the location. The greater the overlap, the greater the extent to which the user hears a blending together of sounds, in one embodiment.

The region covered by a visual element 120 is related to the “region of influence” of that source channel, in one embodiment. The greater the size of the visual element 120, the greater is the potential for its associated sound to blend into the sounds of other channels, in one embodiment. The blending together of source channels is a separate phenomenon from physical interactions (e.g., constructive or destructive interference) between the sound waves.

### Visual Properties of Visual Elements

Each visual element 120 has visual properties that represent aural properties of the source audio channel as it will be heard by a listener at a reference point in the sound space 110. The following discussion will use an example in which the visual elements 120 are arcs; however, visual elements 120 are not limited to arcs. The visual elements 120 have a property that indicates an amplitude gain to the corresponding source channel, in an embodiment. The height of an arc represents scaled amplitude of its corresponding source channel, in an embodiment. By default, height=1, wherein an arc of height<1 indicates that that source channel has been scaled down from its original state, while an arc of height>1 indicates that it has been scaled up, in an embodiment. Referring again to FIG. 2, the height of one of the arcs has been scaled up as a result of the particular placement of the puck 105, while the height of other arcs has been scaled down.

The width of the portion of an arc at the circumference of the sound space 110 illustrates the width of the region from which the sound appears to originate. For example, an operator may wish to have a gunshot sound effect originate from a very narrow section of the sound space 110. Conversely, an operator may want the sound of a freight train to fill the left side of the sound space 110. In one embodiment, width is represented by splitting an arc into multiple lobes. However, width could be represented in another manner, such as changing the width of the base of the arc along the perimeter of the sound space 110. In one embodiment, the visual elements 120 are never made any narrower than the default width depicted in FIG. 1.

The location of an arc represents the location in the sound space 110 from which the source channel appears to originate from the perspective of a listener in the center of the sound space 110, in one embodiment. Referring to FIG. 2, several of the arcs have been moved relative to their default positions depicted in FIG. 1.

As used herein the term “apparent position of sound origination” or the like refers to the position from which a sound appears to originate to a listener at a reference point in the sound space 110. Note that the actual sound may in fact originate from a different location. As used herein the term “apparent width of origination width of sound origination” or the like refers to the width over which a sound appears to originate to a listener at a reference point in the sound space 110. Note that a sound can be made to appear to originate from a point at which there is no physical speaker 112.

If the number of source channels is different from the number of speakers 112 in the sound space 110, there will still be one visual element 120 per source channel, in an embodiment. For example, if a 5.1 source signal is mapped into a stereo sound space (which lacks a center speaker 112c and rear surround speakers 112d, 112e), the UI 100 will display five different visual elements 120a-120e. Because the sound space 110 has no center speaker 112c, the center source channel content will be appropriately distributed between the left and right front speakers 112b, 112d. However, the visual element 120c for the center source channel will still have a default position at a polar coordinate of 0°, which is the default position for the center channel for a 5.1 source signal.

### The Puck

The puck 105 is a “sound manipulation element” that is initially centered in the sound space 110. By moving the puck 105 forward, backward, left, and/or right in the sound space 110, the operator can manipulate the input signal relative to the output speakers 112. Moving the puck 105 forward moves more sound to the front, while moving the puck 105 backward moves more sound to the rear. Moving the puck 105 left moves more sound to the left, while moving the puck 105 right moves more sound to the right.

Thus, the collective positions of the visual elements 120 are based on the puck 105 position, in an embodiment. Collectively, the visual elements 120 represent a balance of the channels, in one embodiment. For example, moving the puck 105 is used to re-balance the channels, in an embodiment.

Moving the sound in the sound space 110 (or re-balancing the sound) can be achieved with different techniques, which are represented by visual properties of the visual elements 120, in an embodiment. An operator can choose between “attenuating” or “collapsing” behavior when moving sound in this manner. Moreover, the operator can mix these behaviors proportionally, in an embodiment.

The example UI 100 has a single puck 105; however, there might be additional pucks. For example, the can be a main puck 105 and a puck for each source channel. Puck variations are discussed below.

### Attenuation

Attenuation means that the strength of one or more sounds is increased and the strength of one or more other sounds is decreased. The increased strength sounds are typically on the opposite side of the sound space 110 as the decreased strength sounds. For example, if an operator moved the puck 105 forward, the source channels that by default are at the front speakers 112b-112d would be amplified while the source channels that by default are at the rear speakers 112a, 112e would be diminished. As a particular example, ambient noise of the rear source channels that is originally mapped to rear speakers 112a, 112e would gradually fade to nothing, while dialogue of front source channels that is originally mapped to the front speakers 112b-112d would get louder and louder.

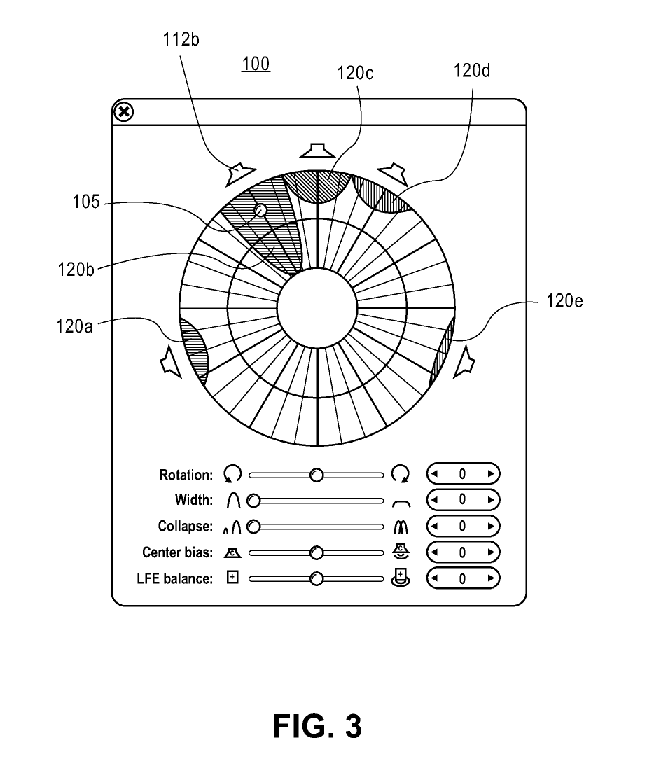

FIG. 3 depicts attenuation in accordance with an embodiment. In this example, the puck 105 has been located near the front left speaker 112b. Each of the source channels is still located in its default position, as represented by the location of the visual elements 120. However, the left front source channel has been amplified, as represented by the higher amplitude of the visual element 120b. Thus, the listener would hear the sound of that channel amplified. The right rear source channel has been attenuated greatly, as represented by the decreased amplitude of the right rear visual element 120e. Thus, the listener would not hear much of the sound from that channel at all. Amplitude changes have been made to at least some of the other channels, as well.

### Collapsing

Collapsing means that sound is relocated, not re-proportioned. For example, moving the puck 105 forward moves more sound to the front speakers 112b, 112c, 112d by adding sound from the rear speakers 112a, 112e. In this case, ambient noise from source channels that by default is played on the rear speakers 112a, 112e would be redistributed to the front speakers 112b, 112c, 112d, while the volume of the existing dialogue from source channels that by default is played on the front speakers 112b, 112c, 112d would remain the same.

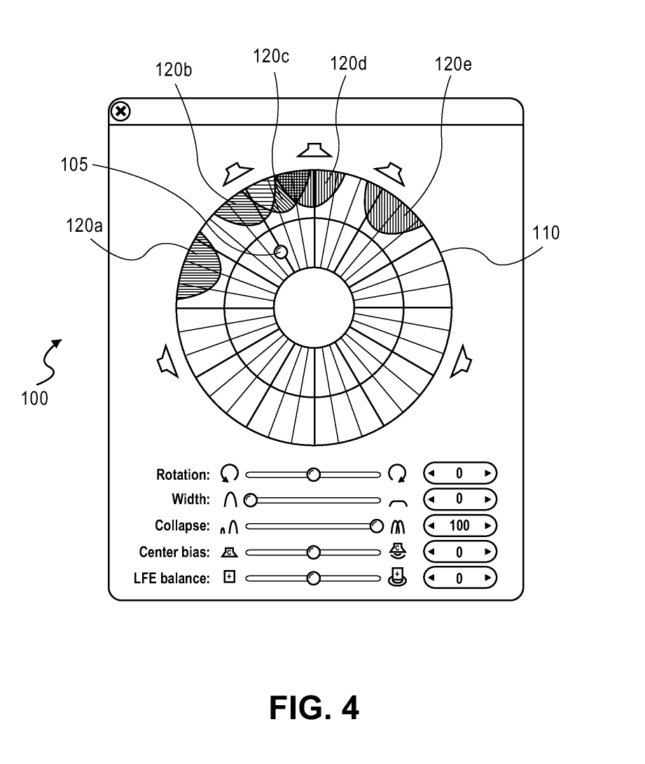

FIG. 4 is a UI 100 with visual elements 120a-120e depicting collapsing behavior, in accordance with an embodiment. Note that the amplitude of each of the channels is not altered by collapsing behavior, as indicated by the visual elements 120a-120e having the same height as their default heights depicted in FIG. 1. However, the sound originating position of at least some of the source channels has moved from the default positions, as indicated by comparison of the positions of the visual elements 120 of FIG. 1 and FIG. 4. For example, visual elements 120a and 120e are represented as “collapsing” toward the other visual elements 120b, 120c, 120d, in FIG. 4. Moreover, visual elements 120c and 120d have moved toward visual element 120b.

### Combination of Attenuation and Collapsing

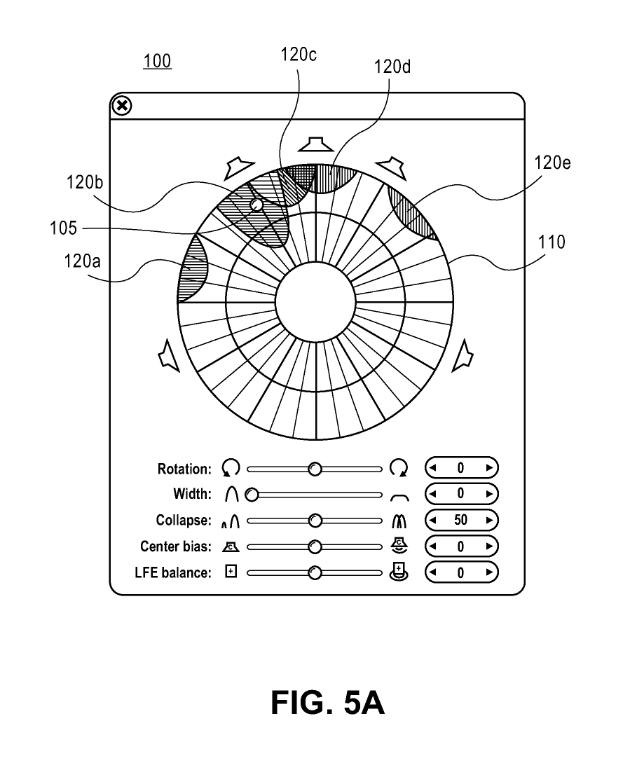

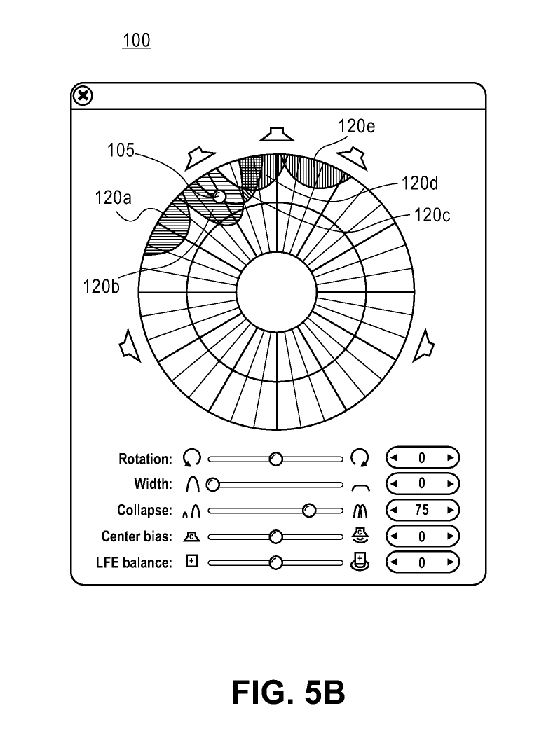

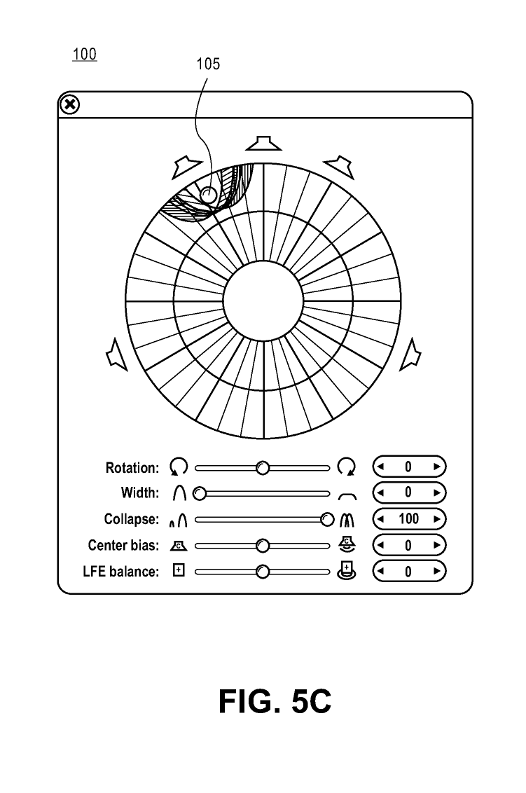

The operator is allowed to select a combination of attenuation and collapsing, in an embodiment. FIG. 3 represents an embodiment in which the behavior is 0% collapsing and 100% attenuating. FIG. 2 represents an embodiment in which the behavior is 25% collapsing and 75% attenuating. FIG. 5A represents an embodiment in which the behavior is 50% collapsing and 50% attenuating. FIG. 5B represents an embodiment in which the behavior is 75% collapsing and 25% attenuating. FIG. 5C represents an embodiment in which the behavior is 100% collapsing and 0% attenuating. In each case, the puck 105 is placed by the operator in the same position.

Note that when there is at least some attenuating behavior, at least one of the visual elements 120 has a different amplitude from the others. Moreover, when more attenuation is used, the amplitude difference is greater. Note a greater amount of collapsing behavior is visually depicted by the visual elements 120 “collapsing” together in the direction of the puck angle (polar coordinate of puck 105).

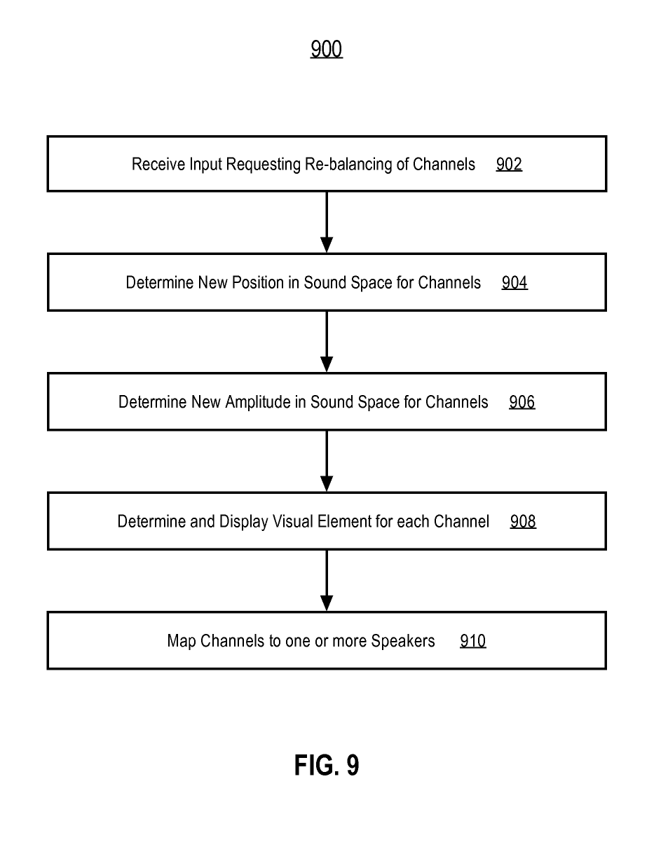

FIG. 9 is a flowchart illustrating a process 900 of re-balancing source channels based on a combination of attenuation and collapsing, in accordance with an embodiment. In step 902, input is received requesting re-balancing channels of source audio in a sound space 110 having speakers 112. The channels of source audio are initially described by an initial position in the sound space 110 and an initial amplitude. For example, referring to FIG. 1, each of the channels is represented by a visual element 120 that depicts an initial position and an initial amplitude. Furthermore, the collective positions and amplitudes of the channels define a balance of the channels in the sound space 110. For example, the initial puck 105 position in the center corresponds to a default balance in which each channel is mapped its default position and amplitude.

The input includes the position of the puck 105, as well a parameter that specifies a combination of attenuation and collapsing, in one embodiment. The collapsing specifies a relative amount by which the positions of the channels should be re-positioned in the sound space 110 to re-balance the channels. The attenuation specifies a relative amount by which the amplitudes of the channels should be modified to re-balance the channels. In one embodiment, the operator is allowed to specify the direction of the path taken by a source channel for collapsing behavior. For example, the operator can specify that when collapsing a source the path should be along the perimeter of the sound space 110, directly towards the puck 105, or something between these two extremes.

In step 904, a new position is determined in the sound space 110 for at least one of the source channels, based on the input. In step 906, a modification to the amplitude of at least one of the channels is determined, based on the input.

In step 908, a visual element 120 is determined for each of the channels based at least in part on the new position and the modification to the amplitude. As an example, referring to FIG. 5A new positions and amplitudes are determined for each channel. In some cases, there may be a channel whose position remains unchanged. For example, referring to FIG. 2, the position of the source channel represented by visual element 120b remains essentially unchanged from its initial position in FIG. 1. In some cases, there may be a channel whose amplitude remains essentially unchanged.

Process 900 further comprises mapping each channel to one or more of the speakers 112, based on the new position for source channels and the modification to the amplitude of source channels, in an embodiment represented by step 910. While process 900 has been explained using an example UI 100 described herein, process 900 is not limited to the example UI 100.

### Slider UI Controls

Referring again to FIG. 1, the UI 100 has a compass 145, which sits at the middle of the sound space 110, and shows the rotational orientation of the input channels, in an embodiment. For example, the operator can use the rotate slider 150 to rotate the apparent originating position of each of the source channels. This would be represented by each of the visual elements 120 rotating around the sound space 110 by a like amount, in one embodiment. For example, if the source signal were rotated 90° clockwise, the compass 145 would point to 3 o'clock. It is not a requirement that each visual element 120 is rotated by the exact same number of degrees.

The width slider 152 allows the operator to adjust the width of the apparent originating position of one or more source channels. In one embodiment, the width of each channel is affected in a like amount by the width slider 152. In one embodiment, the width of each channel is individually adjustable.

The collapse slider 154 allows the operator to choose the amount of attenuating and collapsing behavior. Referring to FIG. 2, the UI 100 may have other slider controls such as a center bias slider 256 to control the amount of bias applied to the center speaker 112c, and an LFE balance slider 258 to control the LFE balance.

### Process Flow in Accordance with an Embodiment

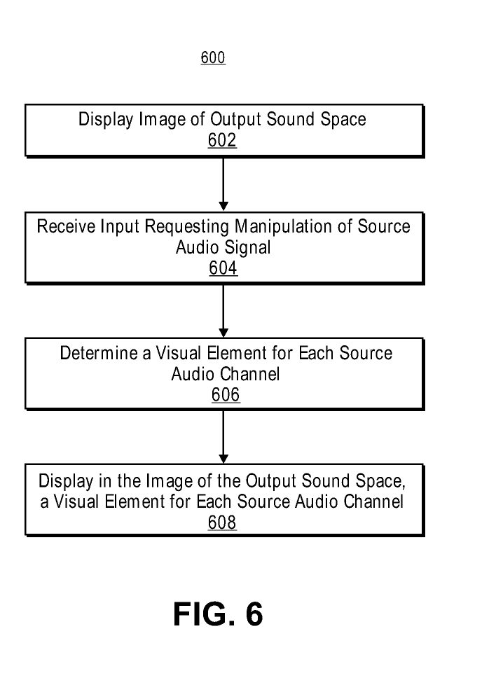

FIG. 6 is a flowchart illustrating a process 600 of visually presenting how a source audio signal having one or more channels will be heard by a listener in a sound space 110, in accordance with an embodiment. In step 602, an image of a sound space 110 having a reference listening point is displayed. For example, the UI 100 of FIG. 1 is displayed with the reference point being the center of the sound space 110.

In step 604, input is received requesting manipulation of a source audio signal. For example, the input could be operator movement of a puck 105, or one or more slide controls 150, 152, 154, 256, 258.

In step 606, a visual element 120 is determined for each channel of source audio. In one embodiment, each visual element 120 represents how the corresponding input audio channel will be heard at the reference point.

In one embodiment, each visual element 120 has a plurality of visual properties to represent a corresponding plurality of aural properties associated with each input audio channel as manipulated by the input manipulation. Examples of the aural properties include, but are not limited to position of apparent sound origination, apparent width of sound origination, and amplitude gain.

In addition to displaying the visual element 120, the UI 100 may also display a representation of the signal strength of the total sound from each speaker 112.

In step 608, each visual element 120 is displayed in the sound space 110. Therefore, the manipulation of channels of source audio data is visually represented in the sound space 110. Furthermore, the operator can visually see how each channel of source audio will be heard by a listener at the reference point.

### Input Parameters

The following are example input parameters that are used herein to explain principles of determining values for visual parameters of visual elements 120, in accordance with an embodiment of the present invention. Each parameter could be defined differently, not all input parameters are necessarily needed, and other parameters might be used. The parameter “audio source default angles” refers to a default polar coordinate of each audio channel in the sound space 110. As an example, if the audio source is modeled after 5.1 ITU-R BS.775-1, then the five audio channels will have the polar coordinate {110°, −30°, 0°, +30°, +110°} in the sound space 110. FIG. 1 depicts visual elements 120 in this default position for five audio channels.

The position the puck 105 is defined by its polar coordinates with the center of the sound space 110 being the origin and the center speaker 112c directly in front of the listener being 0°. The left side of the sound space ranges to −180° directly behind the listener, and the right side ranges to +180° directly behind the listener. The parameter “puck angle” refers to the polar coordinate of the puck 105 and ranges from −180° to +180°. The parameter “puck radius” refers to the position of the puck 105 expressed in terms of distance from the center of the sound space. The range for this parameter is from 0.0 to 1.0, with 0.0 corresponding to the puck in the center of the sound space and 1.0 corresponding to the outer circumference.

The parameter “rotation” refers to how much the entire source audio signal has been rotated in the sound space 110 and ranges from −180° to +180°. For example, the operator is allowed to rotate each channel 35° clockwise, in an embodiment. Controls also allow for users to string several consecutive rotations together to appear to spin the signal >360°, in an embodiment. In one embodiment, not every channel is rotated by the same angle. Rather, the rotation amount is proportional to the distance between the two speakers that source channel is nearest after an initial rotation is applied.

The parameter “width” refers to the apparent width of sound origination. That is, the width over which a sound appears to originate to a listener at a reference point in the sound space 110. The range of the width parameter is from 0.0 for a point source to 1.0 for a sound that appears to originate from a 90° section of the circumference of the sound space 110, in this example. A sound could have a greater width of sound origination than 90°.

As previously discussed, the operator may also specify whether a manipulation of the source audio signal should result in attenuating or collapsing and any combination of attenuating and collapsing. The range of a “collapse” parameter is from 0.0, which represents 100% attenuating and no collapsing, to 1.0, which represents fully collapsing with no attenuating. As an example, a value of 0.4 means that the source audio signal should be attenuated by 40% and collapsed by 60%. It is not required that the percentage of collapsing behavior and attenuating behavior equal 100%.

The UI 100 has an input, such as a slider, that allows the operator to input a “collapse direction” parameter that specifies by how much the sources should collapse along the perimeter and how much the sources should collapse towards the puck 105, in one embodiment. As an example, the parameter could be “0” for collapsing entirely along the perimeter and 1.0 for collapsing sources towards the puck 105.

Process of Determining Visual Properties in Accordance with an Embodiment

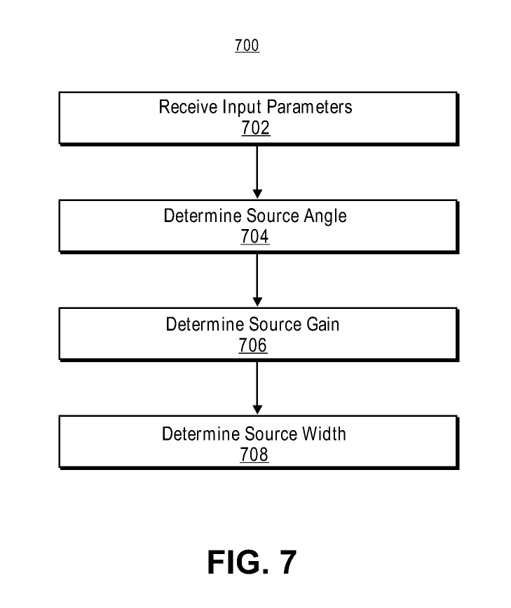

FIG. 7 is a flowchart illustrating a process 700 of determining visual properties for visual elements 120 in accordance with an embodiment. For purposed of illustration, the example input parameters described herein will be used as examples of determining visual properties of the visual elements 120. The visual properties convey to the operator how each channel of the source audio will be heard by a listener in a sound space 110. Process 700 refers to the UI 100 of FIG. 5A; however, process 700 is not so limited. In step 702, input parameters are received.

In step 704, an apparent position of sound origination is determined for each channel of source audio data. An attempt is made to keep the apparent position on the perimeter of the sound space 110, in an embodiment. In another embodiment, the apparent position is allowed to be at any location in the sound space 110. As used herein, the phrase, “in the sound space” includes the perimeter of the sound space 110. The apparent position of sound origination for each channel of source audio can be determined using the following equations:

CollapseFactor=Collapse·PuckRadius Equation 1

position of sound origination=((1.0−CollapseFactor)·(SourceAngle+Rotation))+(CollapseFactor·PuckAngle) Equation 2

For example, applying the above equations results in a determination that the visual element 120e for the right rear channel should be positioned near the right front speaker 112d to indicate that that the sound on that channel would appear to originate from that position.

In step 706, an amplitude gain is determined for each source channel. The amplitude gain is represented by a visual property such as height of a visual element 120 (e.g., arc). The following equations provide an example of how to determine the gain.

PuckToSourceDistanceSquared=(puck.x−source.x)²+(puck.y−source.y)² Equation 3

$$\begin{matrix}RawSourceGain = Collapse + \frac{1.0 - Collapse}{\begin{matrix}Steepness Factor + \\ PuckToSourceDistanceSquared\end{matrix}} & Equation 4 \\ TotalSourceGain = {\sum }_{i = 1}^{n} RawSourceGain ( i ) & Equation 5 \\ amplitude gain = \sqrt{\frac{RawSourceGain \cdot NumberOfSources}{TotalSourceGain}} & Equation 6\end{matrix}$$

Equation 3 is used to determine the distance from the puck 105, as positioned by the operator, to the default position for a particular source channel. Equation 4 is used to determine a raw source gain for each source channel. In Equation 4, the steepness factor adjusts the steepness of the falloff of the RawSourceGain. The steepness factor is a non-zero value. Example ranges in the value are from 0.1-0.3; however, value can be outside of this range. Equation 5 is used to determine a total source gain, based on the gain for the individual source channels. Equation 6 is used to determine an amplitude gain for each channel, based on the individual gain for the channel and the total gain.

In step 708, an apparent width of sound origination for one or more channels is determined.

width of sound origination=(1.0−CollapseFactor)·Width·90° Equation 7

Equation 7 determines a value for the width in degrees around the circumference of the sound space 110. The parameter “Width” is a parameter provided by the operator. As previously discussed the width parameter ranges from 0.0 for a point source to 1.0 for a sound that should appear to originate from a 90° section of the circumference of the sound space. The collapse factor may be determined in accordance with Equation 1.

### Morphing a Visual Element into Multiple Lobes

The visual elements 120 move around the circumference of the sound space 110 in response to puck movements, in an embodiment. The direction of movement is determined by the position of the puck 105. However, when the puck 105 is moved on a path that is roughly perpendicular to the original location of an input channel, the visual element 120 is split into two portions such that one portions travel around the circumference in one direction, while the other portion travels around this circumference in the opposite direction, in an embodiment. The two portions may or may not be connected.

As an example, a monaural sound of a jet may be initially mapped to the single center speaker 112c. As the operator moved the puck 105 directly back and away from the center speaker 112c, the input channel would split and be subsequently moved toward the left front speaker 112b and right front speaker 112d, and ultimately to left surround speaker 112a and right surround speaker 112e. The listener would experience the sound of a jet approaching and moving over and beyond his position.

In response to the position of the puck 105, the shape of a visual element 120 is morphed such that it has multiple lobes, in one embodiment. For example, if the puck 105 is placed roughly opposite from the default position of a particular source channel, the visual element 120 for the source channel is morphed into two lobes, in one embodiment. Referring to FIG. 8, the puck 105 is positioned by the operator on the opposite side of the sound space 110 from the default position)(−30° of the left front source channel. In this case, the shape of the visual element 120b is morphed such that it has two lobes 820a, 820b. It is not required that the two lobes 820a, 820b are connected in the visual representation.

Thus, the operator has placed the puck at a polar coordinate of +140°. The diameter line 810 illustrates that the puck 105 is directly across from the −40° polar coordinate (“puck's opposite position”). Thus, the puck 105 is positioned 10° from directly opposite the default position of the left front source channel. In one embodiment, if the puck 105 is within ±15° of the opposite of the default position of a source channel, the visual element 120 for the source channel is morphed into two lobes 820a, 820b, one on each side of the diameter 810.

The visual element 120b is morphed into a lobe 820a at −90° and a lobe 820b at −10°. Note that the lobe 820b at +10° is given a greater weight than the lobe 820a at −90°. The process of determining positions and weights for the lobes 820 is as follows, in one embodiment. First Equations 1 and 2 are used to determine an initial position for the visual element 120. In this case, the initial position is +10°, which is the position of one of the lobes 820b. The other lobe 820a is positioned equidistant from the puck's opposite position on the opposite side of the diameter line 810. Thus, the other lobe 820b is placed at −90°.

Equation 8 describes how to weight each lobe 820a, 820b. The weight is used to determine the height of each lobe 820 to indicate the relative amplitude gain of that portion of the visual element 120 for that channel, in one embodiment.

0.5·cos((angleDifference+15°/60°) Equation 8

In Equation 8, the “angle difference” is the difference between the puck's opposite polar coordinate and the polar coordinate of the respective lobe 820a, 820b.

### Relative Output Magnitude and Absolute Output Magnitude

In one embodiment, a given visual element 120 shows a relative amplitude of its corresponding source channel. For example, the height of an arc represents the amount by which the amplitude of that channel has been scaled. Thus, even of the actual sound on the channel changes over time, the height of the arc does not change, providing that there is no change to input parameters that require a change to the scaling. An example of such a change is to move the puck 105 with at least some attenuating behavior.

In another embodiment, the visual elements 120 show the actual amplitude of its corresponding sound channel over time. For example, the height of an arc might “pulsate” to demonstrate the change in volume of audio output associated with the source channel. Thus, even if the puck 105 stays in the same place, as the actual volume of a particular channel changes over time, the height of the arc changes.

In one embodiment, the visual elements 120 show a combination of relative and actual amplitude. In one embodiment, the visual elements 120 have concentric arcs. One of the arcs represents the relative amplitude with one or more other arcs changing in response to the audio output associated with the source channel.

### Three-Dimensional Sound Spaces

In one embodiment, the UI 110 represents the sound space 110 in three-dimensions (3D). For example, the speaker 112 locations are not necessarily in a plane for all sound formats (“off-plane speakers”). As particular examples, a 10.2 channel surround has two “height speakers”, and a 22.2 channel surround format has an upper and a lower layer of speakers. Some sound formats have one or more speakers over the listener's head. Various techniques can be used to have the visual elements 120 represent, in 3D, the apparent position and apparent width of sound origination, as well as amplitude gain.

In one embodiment, the sound space 110 is rotatable or tiltable to represent a 3D space. In one embodiment, the sound space 110 is divided into two or more separate views to represent different perspectives. For example, whereas FIG. 1 may be considered a “top view” perspective, a “side view” perspective may also be shown for sound effects at different levels, in one embodiment. As a particular example, a side view sound space 110 might depict the relationship of visual elements 120 to one or more overhead speakers 112. In still another embodiment, the UI 100 could depict 3D by applying, to the visual elements 120, shading, intensity, color, etc. to denote a height dimension.

The selection of how to depict the 3D can be based on where the off-plane speakers 112 are located. For example, the off-plane speakers 112 might be over the sound space 110 (e.g., over the listener's head) or around the periphery of the sound space 110, but at a different level from the “on-plane” speakers 112.

In an embodiment in which there are speakers 112 above the sound space 110, instead of moving the visual elements 120 around the perimeter of the sound space 110, the visual elements 120 could instead traverse across the sound space 110 in order to depict the sound that would be directed toward speakers 112 that are over the reference point.

In an embodiment in which the speakers 112 are on multiple vertical planes, but still located around the outside edge of the sound space 110, adjustments to shading, intensity, color, etc. to denote where the visual elements 120 are relative to the different speaker planes might be used.

### Visual Element Variations

In the embodiments depicted in several of the Figures, the visual elements 120 are at the periphery of the sound space 110. In one embodiment, the visual elements 120 are allowed to be within the sound space 110 (within the periphery).

The shape of the visual elements 120 is not limited to being arcs. In one embodiment, the visual elements 120 have a circular shape. In one embodiment, the visual elements 120 have an oval shape to denote width. Many other shapes could be used to denote width or amplitude.

### Puck Variations

In one embodiment, there is a main puck 105 and one satellite puck for each source channel. The satellite pucks can be moved individually to allow individual control of a channel, in one embodiment. As previously mentioned, the main puck 105 manipulates the apparent origination point of the combination of all of the source channels, in an embodiment. Each satellite puck manipulates represents an apparent point of origination of the source channel that it represents, in one embodiment. Thus, the location in the sound space 110 for each source channel can be directly manipulated with a satellite or “subordinate puck” for that source. The subordinate pucks move in response to movement of the main or “dominant puck”, in an embodiment. The movement of subordinate pucks is further discussed in the discussion of variable direction of collapsing a source.

A puck 105 can have any size or shape. The operator is allowed to change the diameter of the puck 105, in one embodiment. A point source puck 105 results in each channel being mapped equally to all speakers 112, which in effect results in a mono sound reproduction, in an embodiment. A larger diameter puck 105 results in the effect of each channel becoming more discrete, in an embodiment.

### Process of Panning Multiple Channels in Accordance with an Embodiment

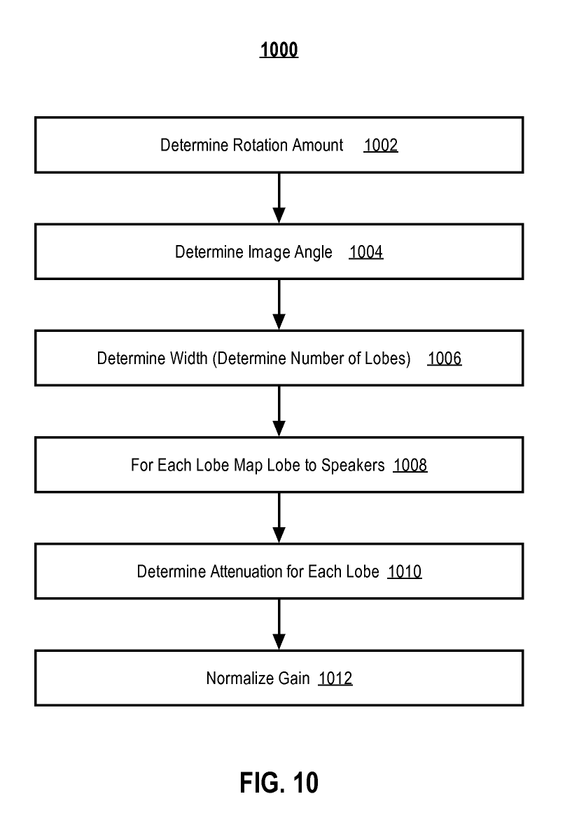

FIG. 10 is a flowchart illustrating a process 1000 of panning multiple channels, in accordance with an embodiment. Process 1000 will be explained using an example UI 100 described herein; however, process 1000 is not limited to the example UI 100. In step 1002, a position in the sound space 110 is determined for each channel, based on a rotation input. The rotation is based on the position of the rotation slider 150, in one embodiment. In one embodiment, each source channel is rotated by the same amount. For example, if the rotation is 45 degrees, then each channel is rotated in the sound space 110 by 45 degrees. However, equal rotation of all channels is not required. An example technique for determining unequal rotation is discussed below.

In step 1004, an image angle is determined for each channel, based on a desired amount of collapsing behavior and the position of the puck 105 in the sound space 110. The image angle is also based on the configuration (e.g., number and placement of speakers) of the sound space 110 and an initial position of the channels. As an example, the initial position could be the default positions represented by the visual elements 120 in FIG. 1. However, the initial position is not limited to the default position. The image angle will largely determine a new position for the visual elements 120. However other factors, such as the width of sound origination can also affect the position of visual elements 120.

In one embodiment, the position of the source channel moves around the perimeter based on how far the puck 105 is from the center of the sound space 110 and the angle of the puck 105. Equation 9 provides a simplified algorithm for determining the channel position in which “R” is the distance of the puck 105 from the center of the sound space 110 with “0” being at the center and “1” being at the perimeter. Furthermore, “C” is a collapse amount, which is specified as a fraction between 0 and 1. The collapse amount may be controlled by the operator via a slider 152. SourceAngle is the initial angle of the source channel and PuckAngle is the angle of the puck 105.

ResultantAngle=SourceAngle·(1−R·C)+PuckAngle·(R·C) Equation 9

In another embodiment, the position of the source channel is allowed to move inside of the perimeter of the sound space 110.

In step 1006, a width of sound origination of each channel is determined. In one embodiment, determining the width includes splitting the source channel into multiple lobes. FIG. 8 depicts an example of a visual element 120, which represents a source channel, split into two lobes 820 in response to the puck 105 being positioned on the opposite side of the sound space 110 from the visual element 120. However, splitting a source channel is not limited to the example of FIG. 8.

In one embodiment, the source channel is split based on the previously discussed width parameter. As an example, if the width parameter specifies that the width of sound origination should be 90 degrees, then the source channel is split into multiple lobes 820 that are distributed across the 90 degree range. For example, the source could be split into two lobes 820 that are separated by 90 degrees. However, the source channel could be split into more than two lobes 820. Thus, the lobes 820 are not required to be at the ends of the width of sound origination. Thus, referring again to FIG. 8, the visual element could have any number of lobes 820.

In step 1008, source channels are mapped to speakers 112. If the source channel has been split into lobes 820, then each lobe 820 is mapped to one or more speakers 112, in an embodiment. In one embodiment, each source channel that is positioned between two speakers 112 is mapped to those two speakers 112. However, a source channel can be mapped to more than two speakers 112. In one embodiment, the source channel (or lobe 820) is faded to the two adjacent speakers 112. Example techniques for fading include, but are not limited to, equal power and equal intensity. Source channels (or lobes 820) that are located at, or very close to, a speaker 112 may be mapped to just that speaker 112.

In step 1010, a gain is determined for each source channel. If the source channel has been split into lobes 820, then a gain is determined for each lobe 820, in an embodiment. The gain is also based on the configuration of the sound space 110. That is, the number and location of speakers 112 is an input to the gain determination, in an embodiment. Further, the sound level of a speaker 112 is an input, in an embodiment.

In one embodiment, the gain is based on two or more components, wherein the weighting of each component is a function of the puck 105 position. For example, a first component may be that that gain is proportional to the inverse of the distance of the channel to the puck 105. The distance can be measured in Cartesian coordinates. A second component may be adding “x” dB of gain to a point of the circumference at the puck angle. An example value for “x” is 6 dB. This added gain is divided between adjacent enabled speakers 112, using any fading technique. In one embodiment, Equation 10 is used to apply the weighting of the two components.

(1−R²)·A+R²·B Equation 10

In Equation 10, “A” is the inverse squared component, “B” is the adding “x” dB component, “R” is the distance of the puck 105 from the center of the sound space 110. Thus, when the puck 105 is relatively near the center, the inverse square component dominates; and when the puck 105 is near the perimeter, the adding “x” dB component dominates.

Note that after applying the foregoing steps, the net change in the gains of each individual channel could result in an increase or a decrease in the net volume of sound. In step 1012, the gain of each channel is normalized such that the overall process 1000 does not result in a substantial change in the total sound volume. In one embodiment, gain normalization includes a step of computing an average based on the gains of each channel and then compensating the gain for each channel based on the average.

In one embodiment, a normalization technique calculates a mathematical average of the gain of each channel and then, for each channel, divides the channel gain by the mathematical average. However, the average can be based on a function of the channel gain, such as the square root, the square, or a trigonometric function (e.g., cosine). Alternatively, the average may be a term inside a function instead of simply being a divisor. For example, in one embodiment, each final source gain is computed from the square root of the product of the raw source gain and the inverse of the average of the raw source gains. For example, the average of the square root of the gain each channel is determined, as in Equation 11.

$$outputGain ( i ) = \sqrt{\frac{sourceGain ( i )}{averageGain}} \qquad Equation 11$$

### Collapsing Along the Perimeter of the Sound Space

In one embodiment, the visual elements 120 are kept at the outer perimeter of the sound space 110 in response to changes in the puck 105 position. For example, referring to FIG. 4, with the puck 105 is moved forward and to the left, each of the visual elements 120 is represented as moving along the perimeter of the sound space 110.

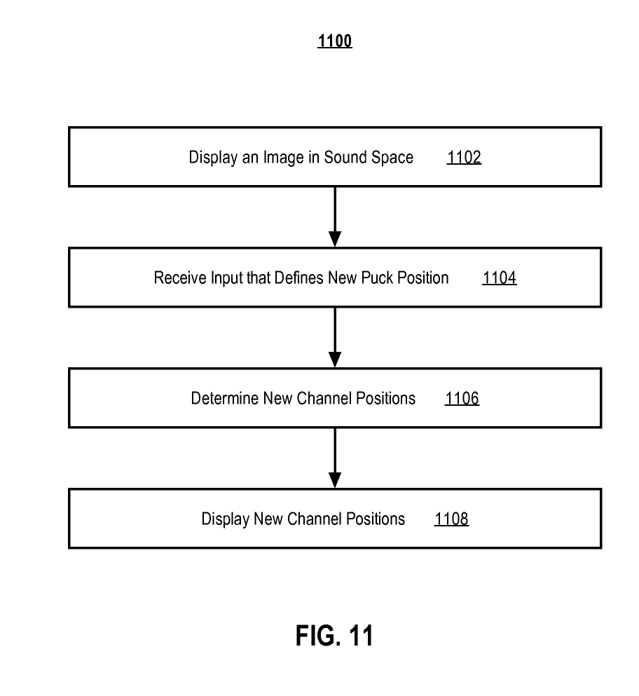

FIG. 11 depicts a process 1100 of collapsing sound along a perimeter of a sound space 110, in accordance with an embodiment. In step 1102, an image is displayed that represents a sound space 110 having a perimeter. The perimeter is depicted as being circular in several of the Figures herein, but is not limited to being circular. The image also displays a position for each channels of source audio, wherein the collective positions of the channels is based on a position of a reference point in the sound space 110. The reference point is the puck 105, in one embodiment.

In step 1104, input is received that defines a new position of the reference point in the sound space 110. In step 1106, based on the new location of the reference point, a new position is determined for at least one of the source channels, wherein the new position for the source channels is kept substantially along the perimeter of the sound space 110.

In step 1106, the new position for the source channels is displayed in the image. For example, referring to FIG. 4 a new position is determined for four of the channels. The channel represented by visual element 120b has not moved in the example because the puck 105 was moved directly towards that visual element 120b. In some cases, each visual element 120 will receive a new position. For example, if the puck 105 is moved to a point that does not correspond to the initial position of any visual element 120, then each visual element 120 may receive a new position. The position of the channels is represented by the visual elements 120 as being along the perimeter to represent that the sound should seem to originate from the perimeter of the sound space 110. While process 1100 has been explained using an example UI 100 described herein, process 1100 is not limited to the example UI 100.

### Variable Direction of Collapsing a Source

In one embodiment, the path along which collapsed source channels take when collapsing is variable. As previously discussed, collapsing refers to re-positioning a sound to achieve re-balancing. Thus, the path along which a source channel is re-positioned can be specified by the operator. In one embodiment, the variation of the path is from the perimeter of the sound space 110 to one that is directly towards the puck 105.

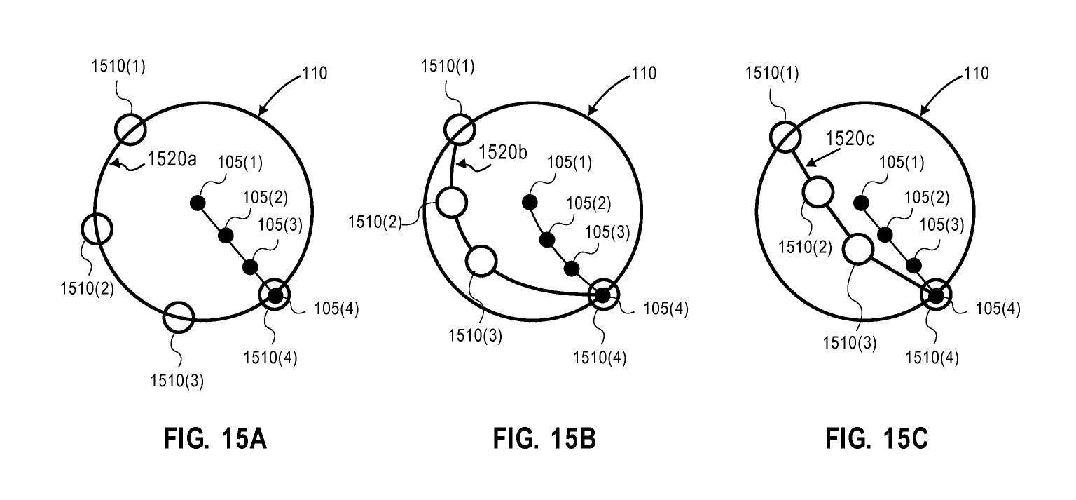

For example, FIGS. 15A, 15B, and 15C illustrate three different lines 1520a, 1520b and 1520c along which a single source channel is collapsed for the same puck 105 movement, in accordance with an embodiment of the present invention. As an example, lines 1520a, 1520b and 1520c correspond to a “collapse parameter” of 0.0, 0.5, and 1.0, respectively. There may be multiple sources, but others are not shown so as to not obscure the diagrams.

In FIG. 15A, the source channel is collapsed entirely along line 1520a at the perimeter of the sound space 110. The source channel has four positions 1510(1)-1510(4), which correspond to the four puck positions 105(1)-105(4).

In FIG. 15C, the line 1520c indicates that the source channel is collapsed essentially directly towards the puck 105. Again, the source channel has four positions 1510(1)-1510(4), which correspond to the four puck positions 105(1)-105(4).

FIG. 15B represents a case in which collapsing is somewhere between the extreme of collapsing along the perimeter and collapsing directly towards the puck 105, as represented by line 1520b. Again, the source channel has four positions 1510(1)-1510(4), which correspond to the four puck positions 105(1)-105(4). The sound space 110 is not limited to having a circular perimeter.

In one embodiment, there is a main puck 105 and a subordinate puck for each source. In one embodiment, a subordinate puck move in response to the direction in which its source channel is being collapsed.

### Example Equations for Source Placement with Variable Path

The following are example equations for determining source placement when sources are allowed to move along a variable path, in accordance with an embodiment. As an example, Equations 12-16 could be used instead of Equation 2 in a variation of process 700. Equation 1 is re-stated for convenience. Equations 15 and 16 can be used to determine an “x” and a “y” coordinate instead of Equation 2. PathLinearity in Equation 14 is based on the “collapse direction” parameter, in one embodiment.

CollapseFactor=Collapse·PuckRadius Equation 1

RotatedSourceAngle=SourceAngle+Rotation Equation 12

AngleOfSoundOrigination=((1.0−CollapseFactor)·RotatedSourceAngle)+(CollapseFactor·PuckAngle) Equation 13

LinearityFactor=CollapseFactor·PathLinearity Equation 14

PositionOfSoundOrigination.x=((1.0−LinearityFactor)·sin(AngleOfSoundOrigination)+(LinearityFactor·sin(puckAngle)) Equation 15

PositionOfSoundOrigination.y=((1.0−LinearityFactor)·cos(AngleOfSoundOrigination)+(LinearityFactor·cos(puckAngle)) Equation 16

### Unequal Angular Rotation of Source Channels in Sound Space

In order to explain unequal rotation of source channels, an example in which the speakers 112 are positioned in accordance with a 5.1 surround sound space 110 will be used. In a 5.1 surround sound space 110 the speakers 112 the angular distance between speakers 112 is not uniform. For example, the angular distance between left front speaker 112b and center speaker 112c is 30 degrees, whereas it is 80 degrees between left rear speaker 112a and left front speaker 112b.

In one embodiment, the input rotation is converted to a fraction of a distance between speakers 112 in the sound space 110. For example, if the five speakers 112 were uniformly distributed, there would be 72 degrees between each speaker 112. Thus, if the input specifies a 36 degrees clockwise rotation, then the channel should be rotated halfway between two speakers 112. Thus, a source channel with an initial position at the left front speaker 112b would be rotated 15 degrees and a source channel with an initial position at the left rear speaker 112a would be rotated 40 degrees clockwise. Thus, in one embodiment, the rotation for a source channel is proportional to distance between speakers 112 in the sound space 110 that are adjacent to the source channel.

### Arbitrary Number of Source Channels and Arbitrary Number of Speakers

In one embodiment, a multi-channel sound panner can process any number of source channels. Furthermore, if the number of source channels changes during processing, the sound panner automatically handles the change in the number of input channels.

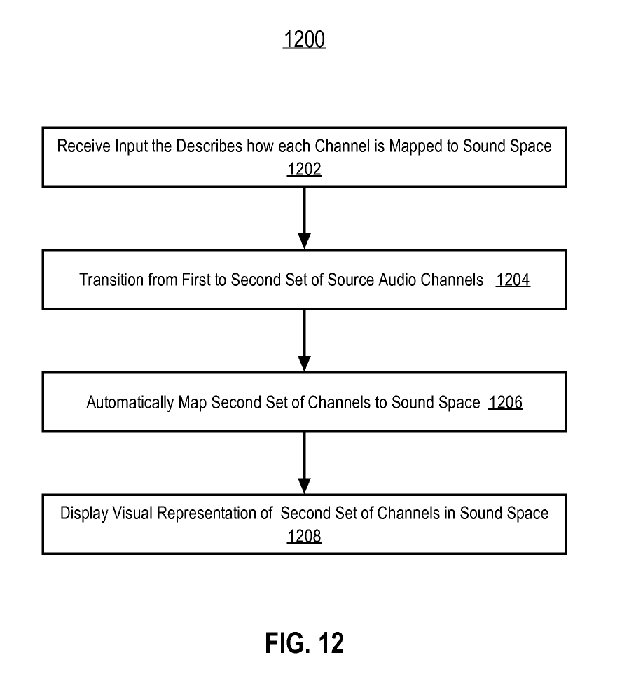

FIG. 12 depicts a process 1200 of automatically adjusting to the number of source channels, in accordance with an embodiment. In step 1202, input is received that affects how each channel of a first set of channels is mapped to a sound space 110. For example, an operator specifies a puck 105 position and slider positions. As an example, the operator may be processing audio data that includes a portion that is recorded in 5.1 surround and a portion that is recorded in stereo.

In step 1204, there is a transition from a first set of channels to a set second set of channels, wherein the first set and the second set have a different number of channels. For example, the transition might be from the 5.1 surround source audio to the stereo source audio. The transition might occur over a period of time. For example, the sound associated with the first set of channels can be fading into the sound associated with the second set of channels.

In step 1206, each channel of the second set of channels is automatically mapped to the sound space 110, based on the input from the operator. Mapping the channels to the sound space 110 can include determining a position and amplitude for each channel. The mapping can also include determining how to map a particular channel to one or more speakers 112.

Prior to the transitioning, a visual representation 120 of each of the first channels is displayed in the sound space 110. During the transitioning, a combination of the first channels and second channels may be displayed. After the transitioning, a visual representation 120 of each of the second channels is displayed in the sound space 110. In one embodiment, during the transitioning, at least one of the visual elements 120 represent a channel from both the first set of channels and a channel from the second set of channels. In another embodiment, during the transitioning, each visual element 120 represents either a channel from the first set of channels or a channel from the second set of channels. The automatic transitioning is performed in the same panner. Furthermore, the operator is not required to request the change in the number of channels that are processed and displayed.

Thus, continuing with the example, the operator would see five visual elements 120 when the source input is 5.1 surround, a combination of the 5.1 surround channels and the stereo channels during a transition period, and two visual elements when the source is stereo. During the transition period, the operator might see three of the visual elements 120 “fade out”. For example, two of the visual elements that represent both a surround sound channel and stereo channel would not fade out, whereas the other visual elements that represent only a surround sound channel would fade out. Alternatively, during a transition period, the operator might see two new visual elements fade in, and five visual elements fade out.

The panning parameters, such as puck 105 position and slider positions, are automatically applied to map the different source audio to the sound space 110. While process 1200 has been explained using an example UI 100 described herein, process 1200 is not limited to the example UI 100.

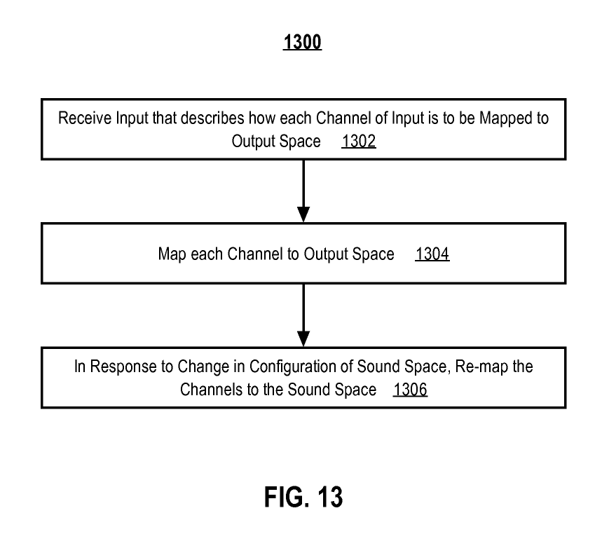

FIG. 13 depicts a process 1300 of automatically adjusting to a change in the configuration of the sound space 110, in accordance with an embodiment. As previously discussed, the operator can disable a speaker 112 or turn down the volume of a speaker 112. Furthermore, the location of a speaker 112 in the sound space 110 can be moved. In step 1302, input is received that affects how each source channel is mapped to the sound space 110. For example, an operator specifies a puck 105 position and slider positions.

Step 1304 is mapping each of the channels to the sound space 110. Mapping the channels to the sound space 110 can include determining a position and amplitude for each channel. The mapping can also include determining how to map a particular channel to one or more speakers 112.

In step 1306, in response to a change in the configuration of the sound space 110, the channels are automatically re-mapped to the sound space 110. While process 1300 has been explained using an example UI 100 described herein, process 1300 is not limited to the example UI 100.

The same panner is able to perform both process 1200 and process 1300, in an embodiment. Thus, a single panner is able to handle an arbitrary number of source channels and an arbitrary configuration of a sound space 110.

### Hardware Overview

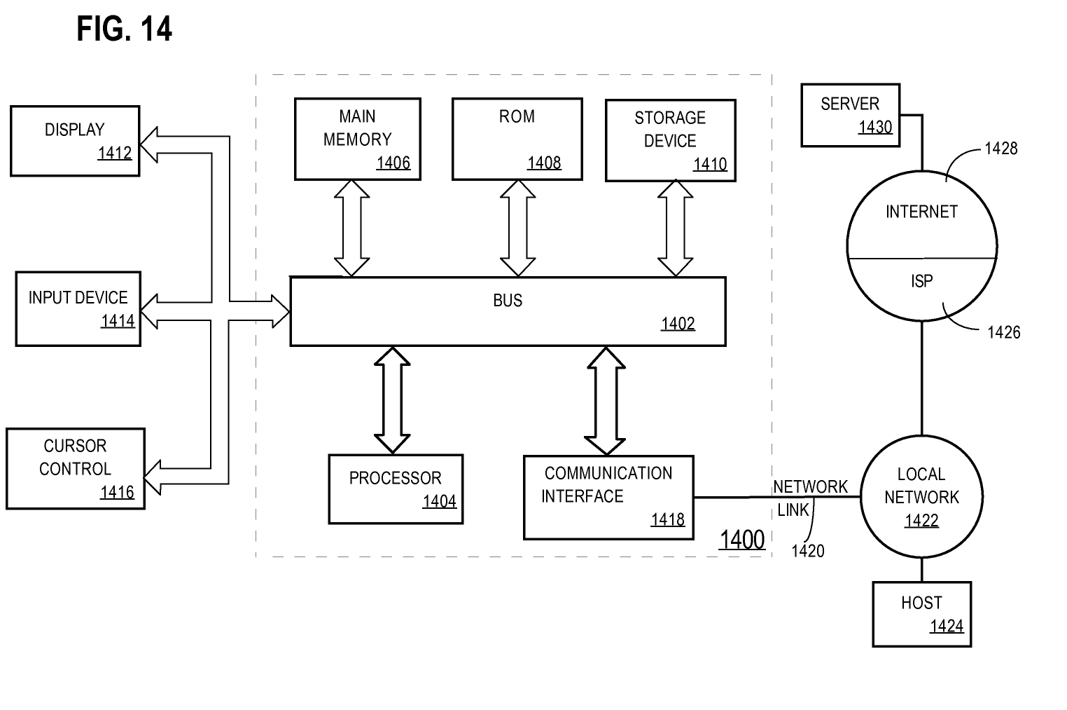

FIG. 14 is a block diagram that illustrates a computer system 1400 upon which an embodiment of the invention may be implemented. Computer system 1400 includes a bus 1402 or other communication mechanism for communicating information, and a processor 1404 coupled with bus 1402 for processing information. Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

The invention is related to the use of computer system 1400 for implementing the techniques described herein. According to one embodiment of the invention, those techniques are performed by computer system 1400 in response to processor 1404 executing one or more sequences of one or more instructions contained in main memory 1406. Such instructions may be read into main memory 1406 from another machine-readable medium, such as storage device 1410. Execution of the sequences of instructions contained in main memory 1406 causes processor 1404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1400, various machine-readable media are involved, for example, in providing instructions to processor 1404 for execution. Such a medium may take many forms, including but not limited to, non-volatile media, volatile media, and transmission media. Non-volatile media includes, for example, optical or magnetic disks, such as storage device 1410. Volatile media includes dynamic memory, such as main memory 1406. Transmission media includes coaxial cables, copper wire and fiber optics, including the wires that comprise bus 1402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1404 for execution. For example, the instructions may initially be carried on a magnetic disk of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams The signals through the various networks and the signals on network link 1420 and through communication interface 1418, which carry the digital data to and from computer system 1400, are exemplary forms of carrier waves transporting the information.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution. In this manner, computer system 1400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving input requesting re-balancing of a plurality of channels of source audio in a sound space having a plurality of speakers, wherein the plurality of channels of source audio are initially described by an initial position in the sound space and an initial amplitude, and wherein the positions and the amplitudes of the channels defines a balance of the channels in the sound space;
based on the input, determining a new position in the sound space for at least one of the source channels;
based on the input, determining a modification to the amplitude of at least one of the source channels, wherein the new position and the modification to the amplitude achieves the re-balancing; and
in response to determining that the input indicates that a particular speaker of the plurality of speakers is to be disabled, automatically transferring, to other speakers adjacent to the particular speaker, sound that was to originate from the particular speaker;
wherein the method is performed by one or more computing devices.

2. The method of claim 1, further comprising mapping at least one of the channels to one or more of the speakers, based on the new position and the modification to the amplitude.

3. The method of claim 1, wherein receiving input includes receiving a relative amount by which the positions of the channels should be re-positioned in the sound space to re-balance the channels and a relative amount by which the amplitudes of the channels should be modified to re-balance the channels.

4. The method of claim 1, further comprising displaying, in a visual representation of the sound space, a visual element for each of the channels based at least in part on the new position and the modification to the amplitude;
wherein the visual element for each particular channel is an arc having a base at a perimeter of the visual representation of the sound space and extending, toward a center of the visual representation of the sound space, a distance that is representative of an amplitude of said particular channel;
wherein extents to which two or more of the visual elements overlap each other is indicative of extents to which sounds from channels corresponding to the visual elements blend into each other.

5. The method of claim 1, wherein the input specifies a reference point in the sound space that is a balancing point for the channels.

6. The method of claim 5, wherein determining the modification to the amplitude is based on a first component for which gain is inversely proportional to the distance of a channel to the reference point and a second component that adds gain to a region of the periphery of the sound space that is nearest to the reference point.

7. The method of claim 1, wherein the input specifies a direction of a path taken by a particular channel of the plurality of channels for collapsing behavior; wherein said path is (a) a first path along a perimeter of said sound space, (b) a second path directly towards a movable user interface element, or (c) in between said first path and said second path; and wherein said collapsing behavior does not alter amplitudes of any of the source channels.

8. A non-transitory computer-readable medium storing instructions which, when executed by one or more processors, cause the one or more processors to perform steps comprising:
receiving input requesting re-balancing of a plurality of channels of source audio in a sound space having a plurality of speakers, wherein the plurality of channels of source audio are initially described by an initial position in the sound space and an initial amplitude, and wherein the positions and the amplitudes of the channels defines a balance of the channels in the sound space;
based on the input, determining a new position in the sound space for at least one of the source channels;
based on the input, determining a modification to the amplitude of at least one of the source channels, wherein the new position and the modification to the amplitude achieves the re-balancing; and
in response to determining that the input indicates that a particular speaker of the plurality of speakers is to be disabled, automatically transferring, to other speakers adjacent to the particular speaker, sound that was to originate from the particular speaker.

9. The non-transitory computer-readable medium of claim 8, wherein said steps further comprise mapping at least one of the channels to one or more of the speakers, based on the new position and the modification to the amplitude.

10. The non-transitory computer-readable medium of claim 8, wherein receiving input includes receiving a relative amount by which the positions of the channels should be re-positioned in the sound space to re-balance the channels and a relative amount by which the amplitudes of the channels should be modified to re-balance the channels.

11. The non-transitory computer-readable medium of claim 8, wherein said steps further comprise displaying, in a visual representation of the sound space, a visual element for each of the channels based at least in part on the new position and the modification to the amplitude;
wherein the visual element for each particular channel is an arc having a base at a perimeter of the visual representation of the sound space and extending, toward a center of the visual representation of the sound space, a distance that is representative of an amplitude of said particular channel;
wherein extents to which two or more of the visual elements overlap each other is indicative of extents to which sounds from channels corresponding to the visual elements blend into each other.

12. The non-transitory computer-readable medium of claim 8, wherein the input specifies a reference point in the sound space that is a balancing point for the channels.

13. The non-transitory computer-readable medium of claim 12, wherein determining the modification to the amplitude is based on a first component for which gain is inversely proportional to the distance of a channel to the reference point and a second component that adds gain to a region of the periphery of the sound space that is nearest to the reference point.

14. The non-transitory computer-readable medium of claim 8, wherein the input specifies a direction of a path taken by a particular channel of the plurality of channels for collapsing behavior; wherein said path is (a) a first path along a perimeter of said sound space, (b) a second path directly towards a movable user interface element, or (c) in between said first path and said second path; and wherein said collapsing behavior does not alter amplitudes of any of the source channels.
